(19) United States
(12) Patent Application Publication
(10) Pub. No.: US 2025/0381551 A1
(43) Pub. Date: Dec. 18, 2025

(54) ARTICLE FOR COOLING, METHODS OF MANUFACTURE AND USES THEREOF

(71) Applicant: University of Connecticut, Farmington, CT (US)

(72) Inventor: Alei AHMADI KASANI, Willington, CT (US)

(21) Appl. No.: 18/876,830

(22) PCT Filed: Jun. 30, 2023
(86) PCT No.: PCT/US2023/026695

§ 371 Date: Dec. 19, 2024

Related U.S. Application Data
(60) Provisional application No. 63/357,353, filed on Jun. 30, 2022.

(51) Int. Cl. B01J 20/28; B01J 20/02; E04H 15/54

(52) U.S. Cl. CPC B01J 20/28026; B01J 20/02; E04H 15/54

(57) ABSTRACT

An article for removing heat from a volume of space upon which it is disposed. The article includes a substrate upon which is disposed a super-hydrophilic dopant. The super-hydrophilic dopant is operative to absorb water from the substrate and to facilitate a conversion of water from a liquid phase to a vapor phase.

### CROSS REFERENCE TO RELATED APPLICATIONS

This application claims priority to U.S. Provisional Patent Application No. 63/357,353, filed Jun. 30, 2022, the entire contents both of which are hereby incorporated by reference in their entirety.

### BACKGROUND

### Field of the Invention

The disclosure relates to an article for cooling, methods of manufacture, and uses thereof.

### Description of the Related Art

Because of solar energy absorption, the temperature of an object or enclosed space on earth can be greater than the ambient temperature. For example, the inside temperature of a tent on a hot, sunny day can be greater than the outside temperature.

Reflective materials have been developed that decrease the absorption of solar energy and can help reduce excessive heating. However, even under perfect environmental conditions, these materials are limited to cooling to the ambient temperature of the surroundings.

Machines or systems that cool an enclosed space, such as fans and air conditioners, generally rely on electrical power to provide the energy for heat transfer. This reliance on electrical power can be inefficient and can increase greenhouse gas emissions.

A need remains for materials that provide cooling in the absence of electrical power.

### SUMMARY

In an embodiment, an article for removing heat from a volume of space upon which it is disposed, includes a substrate upon which is disposed a super-hydrophilic dopant. The super-hydrophilic dopant is operative to absorb water from the substrate and to facilitate a conversion of water from a liquid phase to a vapor phase.

In another embodiment, a tent includes at least one wall in contact with a roof. The combination of the wall and the roof define an enclosed space and are supported by a framework of interconnected frame members. The framework lies within or outside the tent. The at least one wall and/or the roof include a substrate upon which is disposed a super-hydrophilic dopant. The super-hydrophilic dopant is operative to absorb water and to facilitate a conversion of water from a liquid phase to a vapor phase to reduce a temperature of the enclosed space.

In yet another embodiment, a method of manufacturing a tent includes disposing upon a substrate a super-hydrophilic dopant. The substrate with the super-hydrophilic dopant disposed thereon is fabricated into a tent that has at least one wall and/or a roof. The super-hydrophilic dopant is operative to absorb water from the substrate and to facilitate a conversion of water from a liquid phase to a vapor phase to reduce the temperature of a space enclosed within the tent. The above described and other features are exemplified by the following figures and detailed description.

### BRIEF DESCRIPTION OF THE DRAWINGS

Referring now to the figures, which are exemplary embodiments, and wherein the like elements are numbered alike.

FIG. 1 is a side view of an embodiment of a hydrophilic dopant disposed on a substrate;

FIG. 2 is another side view and top view of an embodiment of a hydrophilic dopant disposed on a substrate;

FIG. 3 is another side view and top view of an embodiment of a hydrophilic dopant disposed on a substrate;

FIG. 4 is another side view and top view of an embodiment of a hydrophilic dopant disposed on a substrate;

FIG. 5 is a graph illustrating temperature (° F.) versus time (minutes) for ambient air, a normal tent, an IR-reflective tent, and the tent of Example 1 (“this tent”);

FIG. 6 is an embodiment of a tent with a cooling article and external liquid reservoir;

FIG. 7 is an illustration of the static water contact angles on increasingly hydrophilic surfaces; and

FIG. 8 is an illustration of the phenomenon of ultraviolet light induced “superhydrophilicity” of a titanium dioxide surface.

### DETAILED DESCRIPTION

Disclosed herein is an article for cooling, methods of manufacture and uses thereof. The article includes a substrate that has disposed upon and/or within it a hydrophilic dopant that can wick or absorb water. The liquid can be provided from the surrounding environment or from a liquid containing reservoir (hereinafter “reservoir”). The article continuously wicks water from the reservoir (either through the substrate or through the hydrophilic dopant) and simultaneously permits the absorbed water to undergo a phase change from a liquid state to a gaseous state upon being irradiated and/or by ambient temperature conditions. In an embodiment, the irradiation includes ultraviolet radiation. The phase change facilitates a reduction in temperature in a space where the article is used as a covering.

The cooling process of the article relies on the wetted hydrophilic surface(s) absorbing heat and/or radiation and releasing the absorbed energy via evaporation of the liquid from the hydrophilic dopant. The loss of heat to vaporization serves to prevent a space covered with the cooling article from heating above the ambient temperature. In further embodiments, the article serves to reduce the temperature of a space where it as used as covering to a value less than the ambient temperature.

The article is advantageous because it can be used to decrease the temperature of a covered space (e.g., an enclosure such as a tent) and does not use added electrical energy. Accordingly, the use of the article can reduce energy costs and greenhouse gas emissions.

“Ambient temperature,” as used herein, refers to the air temperature of an environment that lies outside of a covered enclosed space or surface temperature of an object.

“And/or” includes any and all combinations of one or more of the associated listed items.

“Superhydrophilic materials,” as defined herein, refer to materials where the water (liquid) apparent contact angle is less than five degrees as measured by ASTM D7334.

“USB,” as used herein, is an abbreviation for Universal Serial Bus.

“Percolation,” as used herein, refers to the transport of liquid and/or vapor through a tenuous network of randomly distributed particles in or on a substrate.

“Percolation threshold,” as used herein, refers to the threshold below which there is no interconnected pathway in the tenuous network of randomly distributed particles that permits a liquid and/or a vapor to be transported from one end of the substrate to another and above which there is such a pathway.

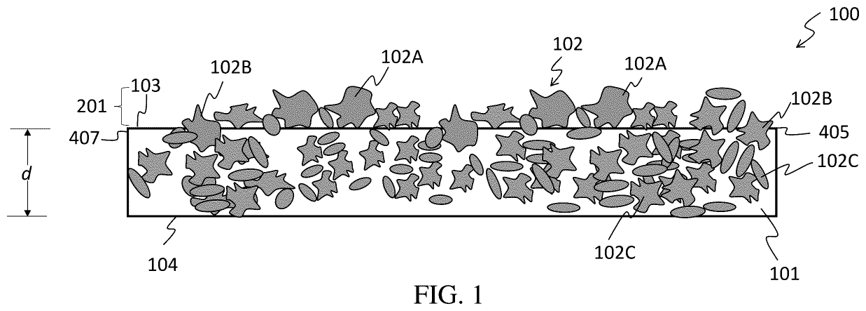

As shown in FIGS. 1-5, an article 100 includes a substrate 101 upon which is disposed a hydrophilic dopant 102.

FIG. 1 is a depiction of a side view of an exemplary embodiment of the article 100. The article 100 includes the substrate 101 upon and/or within which the hydrophilic dopant 102 is disposed. The substrate 101 has a first surface 103 and a second surface 104 that is opposedly disposed to the first surface 103. The first surface 103 and the second surface 104 are a distance “d” apart, where the distance d (which may also be referred to as a “thickness”) is sufficient to completely encompass at least some of the hydrophilic particles. In other words, in some embodiments, the substrate 101 is of a thickness that is greater than the average particle size of the hydrophilic particles. The substrate 101 is flexible and can include a woven or non-woven fibrous textile, a sheet that contains no fibers, or a combination thereof.

The hydrophilic particles 102 may be disposed on one or both surfaces (103, 104) of the substrate 101. The particles 102 may also be partially embedded in the substrate 101 or intertwined between fibers in the fibrous substrates (in which event, some of the particles 102 may appear to be fully encapsulated in the substrate 101, as shown in the side view of the FIG. 1). For example, particles 102A are disposed on the upper surface 103 of the substrate 101, while particles 102B are partially embedded in the substrate 101. Since the substrate includes woven or non-woven fibers, some of the particles (depicted by particles 102C) lie in the interstices of the fibers and are located between the opposing surfaces 103 and 104 of the substrate. Both the substrate 101 and the hydrophilic particles 102 are described in detail below.

The substrate 101 can include knitted, braided, woven or non-woven fibers in the form of a textile (hereinafter textile), or alternatively, comprise an extruded film or sheet (that does not contain fibers) (hereinafter sheet). The substrate 101 can therefore be a sheet, a tarp, a film, a cloth or other suitable structure. Since the article 100 can serve to partially or fully cover an area or a space to facilitate cooling of the area or the space, the substrate 101 is generally large in size covering an area greater than about 1 square meter (m²). The substrate 101 may therefore be larger in area than 1 m², larger than 5 m², and may be larger than 10 m².

The substrate 101 includes an organic polymer in the form of a fibrous textile or a non-fibrous sheet. Organic polymers used in substrate 101 may include synthetic polymers or naturally occurring polymers. The synthetic polymers can be selected from a wide variety of organic polymers such as thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination thereof. In some embodiments, the organic polymers have number average molecular weights greater than 10,000 grams per mole, in some others, greater than 20,000 g/mole and in further embodiments, greater than 50,000 g/mole.

Examples of thermoplastic polymers that can be used in the substrate 101 include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

In some embodiments, the substrate 101 includes natural fibers from plants or animals. Examples of suitable natural fibers include cotton, hemp, linen, wool, silk, or a combination thereof. Textiles that contain blends of natural fibers with synthetic fibers may also be used.

The substrate 101 may include natural fibers in an amount of zero weight percent (wt %) to about 100 wt %, about 25 wt % to about 90 wt %, about 30 wt % to about 75 wt %, based on the total weight of the substrate 101. The substrate 101 may include synthetic fibers in an amount of zero wt % to 100 wt %, about 25 wt % to about 90 wt %, about 30 wt % to about 75 wt %, based on the total weight of the substrate 101.

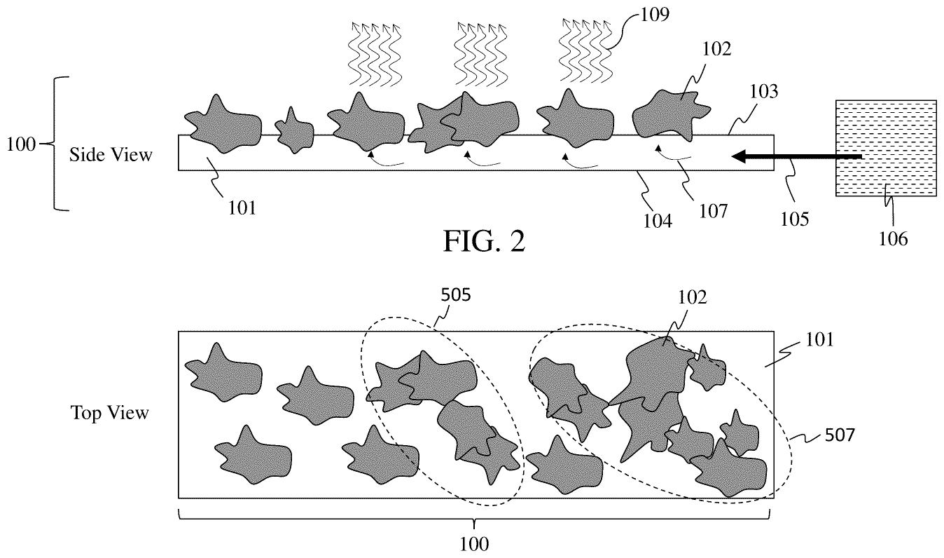

In some embodiments, the substrate 101 includes a hydrophilic material (e.g., a polyacrylamide, a polyamide, or the like) and can absorb water from either the atmosphere or from a reservoir (not shown in FIG. 1 but depicted in FIGS. 2-4) that is in fluid communication with the substrate 101. In some embodiments, the substrate 101 comprises a polyamide or a blend of a polyamide with other polymers. The substrate 101 can include the polyamide in an amount of about 5 wt % to about 100 wt % based on the total weight of the substrate. Within this range the polyamide amount can be about 25 wt % to about 90 wt %, specifically about 30 wt % to about 75 wt %.

In some embodiments, the substrate 101 includes a hydrophobic material (e.g., a polyolefin, a polyester, or the like) and does not absorb water when in the form of a non-fibrous sheet. It is however to be noted that when the textile includes fibers that are hydrophobic (e.g., such as a polyolefin), they can still absorb moisture due to the capillaries present in and between the fibers and intermolecular forces. In an embodiment, hydrophobic polymers (e.g., polyethylene and polyester) can be used combined with other hydrophilic polymers to facilitate water wicking via absorption as well as by capillary action.

In some embodiments, the polymeric material of the substrate 101 includes a polyolefin, mixtures thereof, or mixtures thereof with other polymers. Suitable polyolefins include polyethylenes (including high density polyethylene (HDPE), low density polyethylene (LDPE), medium density polyethylene (MDPE), and linear low density polyethylene (LLDPE)), polypropylenes (including atactic, syndiotactic, and isotactic polypropylenes), and polyisobutylenes. The substrate 101 can include the polyolefin in an amount of about 5 weight percent to about 100 weight percent, about 25 weight percent to about 90 weight percent, about 30 weight percent to about 75 weight percent, based on the total weight of the substrate 101.

The textile or the sheet used for the substrate 101 is robust in order to provide support for the structure (e.g., a tent). In some embodiments, the textile or film has an elastic modulus greater than about 1 GPa (gigapascal), greater than about 1.5 GPa, and greater than about 2.0 GPa up to 3.0 GPa measured as per ASTM D 638. Furthermore, the substrate 101 is environmentally resistant and is capable of maintaining the article's cooling properties upon exposure to the natural elements of wind, rain, and sun. In some embodiments, the substrate 101 has an affinity for water to facilitate wicking of moisture throughout the article 100 during use. In some embodiments, the substrate 101 can be disposed upon additional layers of another material (not shown in the FIG. 1) to provide increased environmental resistance and reusability. An example of an additional layer upon which the article 100 is used is a tent. The article 100 can be retroactively affixed to the roof or sides of a tent to cool the interior spaces within the tent. In further embodiments, the substrate 101 can be physically attached and/or chemically bonded to additional layers of material to provide added strength and versatility.

It is desirable for the substrate 101 to be a wicking substrate—i.e., one where water can be transported from one edge 405 of the surface 103 to an opposing edge 407. This generally occurs when the substrate includes a hydrophilic polymer or when the substrate comprises fibers. Fibrous substrates may be woven or non-woven and the capillaries in the fibers promote wicking. Substrates in sheet form (where the sheet does not contain any fibers) that contain hydrophilic polymers may also permit wicking to occur resulting in the transport of water from one edge 405 of the surface 103 to an opposing edge 407. Substrates in sheet form are generally extruded.

With reference now again to the FIG. 1, the hydrophilic dopant 102 is disposed on one or more the first surface 103, the second surface 104, and the substrate 101. As noted above, the hydrophilic dopant 102 may be disposed on the substrate 101, partially embedded in the substrate 101 or intertwined in the fibers that form a fibrous substrate 101 (in which event it is described as being within the substrate 101).

The hydrophilic dopant 102 can be disposed on the substrate 101 via coextrusion, impregnation, dip coating, slurry coating, spray coating, or other methods. The hydrophilic dopant 101 is in particulate form and may be evenly and uniformly distributed on or within the substrate. When the hydrophilic dopant particles are evenly and uniformly distributed on the substrate, there is generally a periodic spacing between the particles and the thickness of a layer of hydrophilic dopant is substantially even across an entire surface of the substrate 101.

In some embodiments, the hydrophilic dopant 102 can be unevenly distributed on or within the substrate 101. When it is unevenly distributed, the spacing between the hydrophilic dopant particles 102 is aperiodic and the thickness of a layer of the particles 102 may have large variations.

The hydrophilic dopant 102 may also be embedded into the substrate 101 and the hydrophilic dopant particles can penetrate into the substrate to a depth of 1% to 90%, preferably 10% to 75% of the substrate 101. The depth is measured from a surface (e.g., 103 or 104) of the substrate 101 on which the hydrophilic dopant particles are disposed and is expressed as a fraction of the thickness of the substrate.

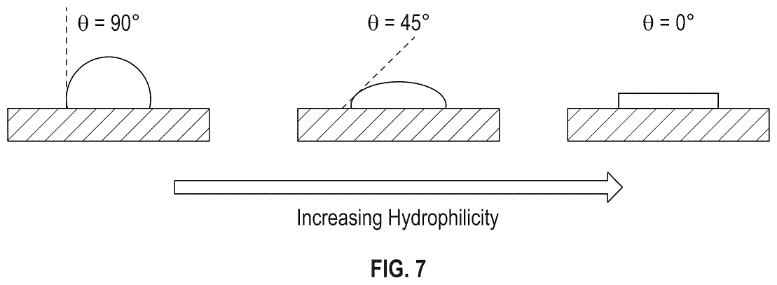

The hydrophilic dopant 102 comprises a super hydrophilic material. Super-hydrophilic materials are described as those having a contact angle of less than 5 degrees with water. The hydrophilic dopant 102 is more hydrophilic than the material used in substrate 101 and therefore draws moisture away from the substrate 101. This does not imply that the flux of water or moisture transfer is always from the substrate 101 to the hydrophilic dopant 102. In localized areas of the article 100 the flux of fluid transfer may be from the hydrophilic dopant 102 to the substrate 101 due to gravity or other local conditions such as temperature. This is discussed later in the FIG. 7. Examples of suitable inorganic super-hydrophilic materials include titanium dioxide, zinc oxide, tungsten trioxide, and silica (SiO₂). In some embodiments, the hydrophilic dopant 102 can be an anatase form of titanium dioxide (TiO₂).

In some embodiments, the average particle size of the hydrophilic dopant 102 is 2 nanometers to 50 micrometers, 5 nanometers to 25 micrometers. In some embodiments, the hydrophilic dopant 102 comprises about 1 wt % to about 70 wt % based on the total weight of the article 100. Within this range the hydrophilic dopant 102 amount can be about 5 wt % to about 50 wt %, about, about 10 wt % to about 25 wt %. In further embodiments, the hydrophilic dopant 102 disposed on the substrate 101 (such as the embodiment shown in FIG. 1) can be a layer having an average thickness of about 2 angstroms to about 100 micrometers, about 10 angstroms to about 50 micrometers, about 5 nanometers to about 25 micrometers. In another embodiment, the hydrophilic dopant 102 comprises about 5 wt % to about 100 wt % based on the total weight of a hydrophilic dopant containing layer 201 of the composition as illustrated in FIG. 1. Within this range the hydrophilic dopant 102 amount can be about 25 wt % to about 95 wt %, specifically about 30 wt % to about 90 wt %.

In an embodiment, the particles of hydrophilic dopant 102 can contact each other to form a plurality of percolating networks on one or more surfaces 103 and 104 of the substrate 101. A percolating network is one where the particles of the network continuously contact at least one or more nearest neighbors to form an unbroken chain of particles that extend from one edge 405 of the surface 103 to an opposing edge 407. A percolating network of hydrophilic dopant particles is useful for facilitating the wicking of water through the hydrophilic dopant layer 201 in addition to the wicking that may occur when the substrate 101 is hydrophilic or includes fibers. The percolating threshold is one where the concentration of particles is sufficient to form a continuous tenuous network of particles that extend from one edge 405 of the surface 103 to an opposing edge 407.

In embodiments where the hydrophilic dopant 102 is at a concentration that meets or exceeds the percolation threshold, the hydrophilic dopant 102 can provide wicking of moisture through the hydrophilic dopant 102. It is therefore desirable to have the hydrophilic dopant 102 at concentrations that exceed the percolation threshold to permit wicking of water from a reservoir (not shown) or from moisture present in the atmosphere.

In another embodiment, the hydrophilic dopant 102 is not present in a concentration to exceed the percolation threshold. In this embodiment, some of the particles contact one or more nearest neighbors, while others may not do so. There are no continuous chains of particles that extend from one edge of the surface to another, but there are a plurality of continuous chains of particles that extend across the network but fall short of extending from one edge of the surface to another. These chains of hydrophilic dopants 102 can also facilitate wicking but the wicking may be less extensive than those situations where the particle concentration lies above the percolating threshold.

In an embodiment, wicking may occur as a result of combined wicking that occurs in both the substrate 101 as well as the hydrophilic dopants 102 disposed on that substrate. In such an event, water transmitted to the hydrophilic dopants may be transported to the substrate and vice versa depending upon the most favorable pathways available for such wicking to occur. The result is that the water can be transported from one edge 405 of surface 103 to an opposing edge 407 as a result of wicking that occurs in both the substrate 101 and the hydrophilic dopants 102.

FIGS. 2-4 depict various exemplary embodiments of the article 100 and provide details on the structure of the various layers as well as the mechanism by which cooling is provided to enclosed spaces that are surrounded by the article 100.

FIG. 2 is an exemplary depiction of a side view and a top view of the article 100 that includes the substrate 101 upon which the hydrophilic dopant 102 is disposed. The substrate includes an upper surface 103 that is opposedly disposed to the lower surface 104. In the FIG. 2, a majority of the hydrophilic dopant 102 particles are not in contact with each other. There are no percolating chains of hydrophilic dopant particles and the particle concentration lies below the percolating threshold. There are only a few chains of particles that contact their nearest neighbors. Ellipses 505 and 507 enclose two such particle chains. In this case, the bulk of the wicking occurs through the substrate 101. Some wicking may occur as a result of a combination of wicking from the substrate to the hydrophilic dopant chains.

A liquid reservoir 106 is in contact with the article 100. Arrow 105 depicts the liquid flow from a reservoir 106 into the substrate 105 via wicking. Arrows 107 depict the flow of moisture from the substrate towards the hydrophilic dopant 102. The arrows 109 depict the evaporation of water vapor from the article 100. When radiation is incident upon the hydrophilic dopant 102, the moisture undergoes a phase change from liquid to vapor and evaporates. The departure of this moisture from the dopant 102 causes the substrate to transport some moisture to the dopant particles because the hydrophilic dopant particles are more hydrophilic than the substrate. The transport of moisture from the substrate 101 to the hydrophilic dopants 102 causes the substrate to wick more water from the reservoir thus replenishing the water available for evaporation in the article 100.

The conversion of water from its liquid to its vapor state occurs because of the absorption of incident radiation upon the article 100 and also optionally because ambient heat (from a higher temperature surrounding) is absorbed by the article 100. Even when the ambient temperature is lower than the temperature inside an enclosure surrounded by article 100, the irradiation of the dopant 102 (and of water) can promote a phase change of water from its liquid to its vapor state. The absorption of radiation and heat by the water results in a cooling of the article 100. Any heat contained in a space enclosed by article 100 will therefore migrate towards the article 100 since heat is transported from a hot region to a cold region. This results in a lowering of temperature in the space enclosed by article 100.

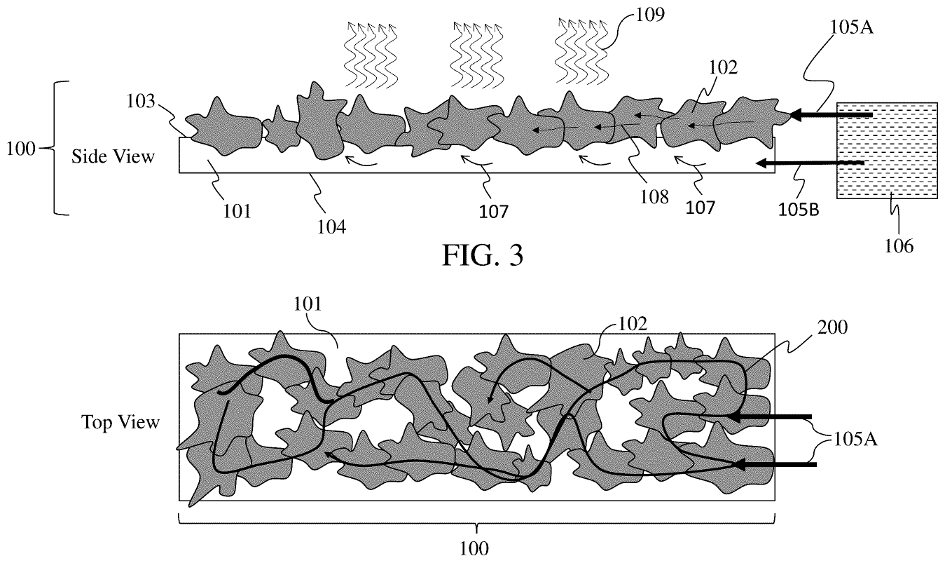

FIG. 3 is another depiction of an exemplary embodiment of a side view and top view of the article 100 that includes a higher concentration of the hydrophilic dopant 102 disposed upon the substrate 101 than a concentration of the hydrophilic dopant 102 present in FIG. 2. In FIG. 3, the concentration of the hydrophilic dopant 102 lies above the percolation threshold for the surface 103. Two exemplary percolation pathways are shown in the top view with the arrows 200. In this embodiment, the substrate 101 can be an extruded polymeric sheet that is not hydrophilic, a woven or non-woven fibrous substrate 101 where the fibers are also not hydrophilic, or a woven or non-woven fibrous substrate 101 where the fibers are hydrophilic.

The use of a substrate 101 based on polymeric sheets that are not hydrophilic permits the retrofitting of existing plastic sheets with the hydrophilic dopant so that it can be instantly used in areas that are damaged by earthquakes, floods, and the like, to protect and preserve life. Plastic sheets manufactured from polyethylene are often easily available as they are used at commercial sites for construction. In the event of an emergency, a slurry of the hydrophilic dopant 102 can be quickly manufactured and applied to the plastic sheet (to function as the substrate 101) in an amount greater than the percolation threshold followed by drying of the slurry to create the article 100, which can then be used as an enclosure to protect life.

When the substrate 101 includes a non-hydrophilic sheet, the bulk of wicking occurs from the reservoir 106 via arrow 105 A through the hydrophilic dopant 102 via percolation pathways 200. Incident radiation and ambient heat then facilitate a phase change in the water (as described above in FIG. 2) which promote cooling of any spaces enclosed by article 100.

When the substrate 101 in FIG. 3 includes a woven or non-woven fibrous substrate 101 where the fibers are not hydrophilic, wicking can occur through the substrate 101 from reservoir 106 via arrow 105B via capillary action. Wicking can also occur via the hydrophilic dopants 102 along percolation pathways 200 (as detailed above). Water present in the substrate can wick towards the hydrophilic dopant 102 and is eventually evaporated. The arrows 109 depict the evaporation of water vapor from the article 100. Water lost from the substrate to the hydrophilic dopant is replenished from reservoir 106 via arrow 105B. The evaporation results in cooling spaces enclosed by article 100.

When the substrate 101 includes a woven or non-woven fibrous substrate 101 where the fibers are hydrophilic, the water can wick into either the hydrophilic dopant 102, the substrate 101 or both the hydrophilic dopant 102 and the substrate 101. Percolation pathways 200 are used to replenish water lost in the hydrophilic dopant. Evaporation of water results in replenishing of water from the reservoir as detailed above, which cools the spaces enclosed by article 100.

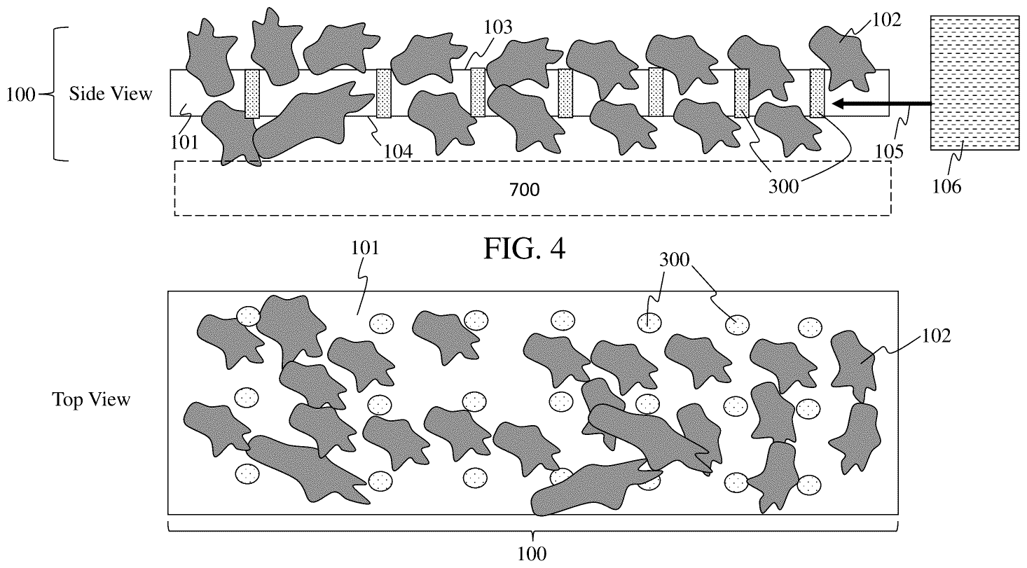

FIG. 4 is another depiction of an exemplary embodiment of the article 100. In this example, the article 100 uses the hydrophilic dopant 102 on the substrate 101 except that in this event it is used on both sides of the substrate 101. The substrate 101 has holes in it that permit transfer of water vapor from one side of the substrate to another. FIG. 4 is a depiction of a side view and top view of the article 100 that includes the substrate 101 with the hydrophilic dopant 102 disposed on both opposing surfaces 103 and 104 of the article 100. The substrate 101 can have holes 300 (also referred to as “pores” or “perforations”) that facilitate the transfer of moisture from one surface of the article 100 to another. In some embodiments, the hydrophilic dopant 102 can be coated inside the pores 300 in the substrate 101 between the article's surfaces. In some embodiments, the pores 300 can be macroscopic holes through the substrate 101. In some embodiments, the pores 300 can be permeable material such as a moisture wicking fabric. The substrate 101 can be a different material type than the material of the pores 300.

As shown, in FIG. 4, the reservoir 106 can be placed at the base of a structure that uses the article 100 so that liquid can readily wick into the article 100. Alternatively, the reservoir 106 can be placed atop the structure so that the liquid can enter the article 100 through the action of wicking and/or gravity. The dopant 102 can be present on the opposing substrate surfaces in different amounts. For example, it can be present on both surfaces at concentrations that are greater than the percolation threshold, it can be present on one surface at a concentration that is greater than the percolation threshold while being present on the opposing surface at a concentration that is less than the percolation threshold, or it can be present on both opposing surfaces at concentrations that are lower than the percolation threshold.

In the embodiment depicted in the FIG. 4, the article 100 with hydrophilic dopants 102 disposed on both sides of the substrate 101 can be retroactively disposed on an existing surface such as the roof or walls of a tent. This side view in the FIG. 4 depicts one such scenario where the article 100 is disposed on a tent roof 700. The combined structure of the article 100 and the tent roof 700 is then in contact with the reservoir 106 from which water is wicked directly to the substrate 101 and/or to the hydrophilic dopant 102. Water from the substrate 101 can then be wicked to the to either the hydrophilic dopant 102 on upper surface 103 or lower surface 104. While the water from surface 103 will evaporate directly into the ambient surroundings, the water from surface 104 will be converted into vapor and trapped in between substrate 101 and the tent roof 700. The holes 300 in the substrate 101 will permit some of this vapor to be transported from beneath surface 104 to upper surface 103 to escape. This embodiment may provide for greater cooling because of the phase conversion occurring on opposing surfaces of the substrate 101. In some embodiments, moisture can travel from the inside surface 104 to the outside surface 103 of the article 100 can facilitate removal of humidity from a covered space.

In some embodiments, the hydrophilic dopant 102 disposed on the substrate 101 can neutralize surface contaminants during photocatalytic and superhydrophilicity processes. In certain embodiments, the hydrophilic dopant 102 can neutralize and/or remove surface contaminants from the article 100 during photocatalytic and superhydrophilicity processes. In further embodiments, the hydrophilic dopant 102 can neutralize and/or remove microbes in the air during photocatalytic and superhydrophilicity processes.

In certain embodiments, the hydrophilic dopant can be disposed on both sides of the substrate 101. In some embodiments, the hydrophilic dopant 102 disposed upon both surfaces 103 and 104 of the article can provide reversibility of the article 100.

The article 100 can also include an effective amount of an additive such as an anti-oxidant, a flame retardant, a drip retardant, a dye, a pigment, a colorant, a stabilizer, an antistatic agent, a plasticizer, a lubricant, and mixtures thereof. The effective amount of the additive varies widely, but the additive can be present in an amount up to about 50 wt %, based on the weight of the article 100.

In some embodiments, the article 100 has a thickness of about 100 micrometers to about 5 millimeters, about 500 micrometers to about 3 millimeters. In some embodiments, the thickness of the substrate 101 is the same as the thickness of the article 100. This is true when the particles are intertwined in the weave of a woven substrate. In further embodiments, the thickness of a layer of the substrate 102 can be less than the thickness of the article 100 as a whole.

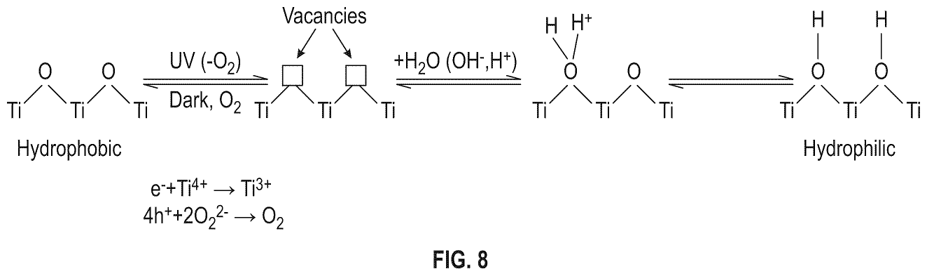

In order to provide some further context as to hydrophilicity, as shown in FIG. 7 from left to right, increasing hydrophilicity of a given surface decreases the contact angle of a drop of water on the surface. In the case of super-hydrophilic materials, the material decreases the contact angle of water on its surface to less than five degrees. This property can enable wicking of moisture across a surface of super-hydrophilic material. For anatase titanium dioxide, ultraviolet (UV) irradiation induces a hydrophilic conversion of a TiO₂ surface as illustrated in FIG. 8. FIG. 8 depicts the progression for converting TiO₂ from a hydrophilic material to a super-hydrophilic material upon being exposed to ultraviolet (UV) radiation. While not wishing to be bound by theory, a surface of titanium dioxide can develop bonding vacancies after exposure to ultraviolet (UV) irradiation. The vacancies serve as hydrophilic sites to spread water across the surface of photo-exposed titanium dioxide. In addition to the increased hydrophilicity of a TiO₂ surface upon UV irradiation, the material's photocatalytic properties can also serve to photodegrade contaminants such as organic pollutants and so forth.

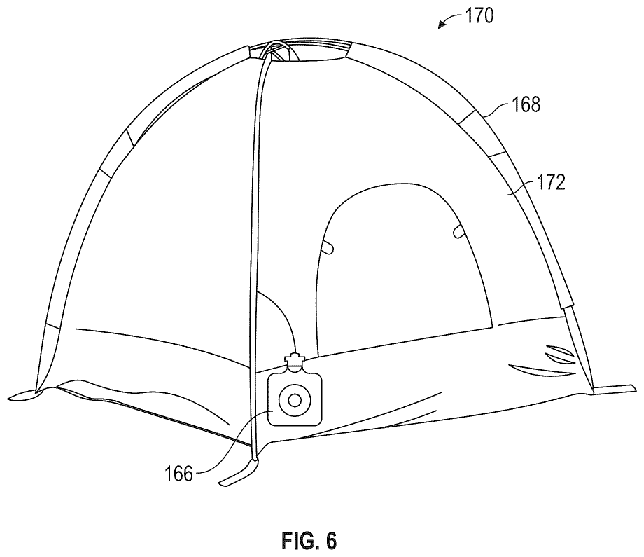

The article 100 described herein can be utilized as a partial or full covering for any space where cooling is desired. It can be used as a direct covering for an enclosed space or alternatively, used retroactively on an already existing surface. In some embodiments, the article 100 can be used to cover an existing surface. FIG. 6 depicts a tent—where the walls of the tent contain article 100 in fluid communication with a reservoir 106. Potential applications of the article 100 include, tents, curtains, tarps, clothing and so forth. In further embodiments, the article 100 can be used in combination with or integrated into other existing materials such as for covering a tent, attachment to a piece of clothing, sporting goods and competitive environments, covering a vehicle, an awning, a covering for a window, and so forth.

In the example of FIG. 6, the tent substantially includes four walls, and is without a conventional roof, however, this depiction does provide an illustration of a tent suited for the technology disclosed herein. As one may imagine, many embodiments will arise where the terminology used herein does not apply squarely thereto. As a further example, it should be recognized that a tent may have only one exterior wall, as in the example of a circular circus tent or yurt. Generally, a tent is a temporary structure that provides an enclosed space for habitation, (where the term “temporary structure” generally refers to a structure not designed and constructed according to building codes to provide for sustained (e.g., year-after-year) usage in a fixed location. The temporary structure includes sheet material disposed over and/or suspended from a framework to provide the enclosed space. Accordingly, descriptions of the tent that include aspects such as a “roof” or a number of walls are merely illustrative and are not limiting of the teachings herein. In other words, the tent may include one or more walls that can be arranged to form a roof. As an additional example, consider a single wall tent, conventionally referred to as a “tee-pee.” The tent may also contain one or more walls and a roof. The roof can therefore be an optional feature in the tent.

As detailed above, the cooling process of the article 100 relies on the heat absorption by a phase change of the liquid into the vapor state. In some embodiments, a portion of the article 100 can be placed in contact with a liquid reservoir 106 as illustrated in FIGS. 2-4. In further embodiments, the article 100 can be placed in contact with more than one reservoir 106. In other embodiments, moisture can be added by spraying or misting a liquid onto the article 100. Liquid can wet the article 100 through the action of wicking, misting, spraying, dripping, or combinations thereof. The reservoir 106 can be placed at the base of a structure that uses the article 100, beside the structure, or atop the structure to facilitate the wetting of the article 100.

Various methods of coating the substrate 101 with the hydrophilic dopant 102 can be used. With reference to the FIGS. 1-4, these methods can include spray coating, dip coating, coating with a roll, painting, electrostatic spray painting, roll milling, and so forth. In other embodiments, the hydrophilic dopant 102 can be disposed in a layer or multiple layers onto the substrate 101. In one embodiment, the hydrophilic dopant can be disposed in a suitable liquid to prepare a slurry. The liquid is preferably water compatible and may include a binder such as cellulose, ethylene glycol, polyethylene glycol, and so on. The binder can sometimes facilitate compatibilization with the water and the dopant. Surfactants may optionally be used if desired.

Suitable solvents for preparing the slurry include solvents such as diethylene glycol mono butyl ether, water, alcohols, methanol, acetonitrile, nitromethane, ethanol, propanol, isopropanol, butanol, benzene, toluene, methylene chloride, carbon tetrachloride, hexane, diethyl ether, tetrahydrofuran, or a combination thereof.

In preparing the slurry, the hydrophilic dopant is present in an amount of 1 to 50 wt %, preferably 2 to 25 wt % weight percent (wt %) based on total slurry weight. The binder is present in an amount of 1 to 40 wt %, preferably 2 to 25 wt %, based on total slurry weight. The solvent constitutes the remainder of the slurry. In an embodiment, the solvent is present in an amount of 10 to 98 wt % of the total slurry weight.

The slurry is then applied to the substrate 101 and dried to form a layer of the hydrophilic dopant 102. The dopant 102 is present in the slurry so that it can form a substantially continuous coating on the substrate 101 after drying.

In some embodiments, the hydrophilic dopant 102 can be incorporated into the substrate 101 by coextrusion with filaments. For example, a polymer base for generating the article 100 can be extruded to charged filaments and then the hydrophilic dopant 102 can be in the form of nanoparticles loaded opposing the charge of the extruded polymer. The coextruded material can be further treated with heat and other conditions to adhere the hydrophilic dopant 102 to the substrate 101. In some embodiments, the hydrophilic dopant 102 can be applied via a pad-dry-cure method. In other embodiments, the hydrophilic dopant 102 can be applied via impregnation into the substrate 101.

In yet another embodiment, the substrate 101 may be extruded into the form of a sheet. A slurry is disposed on the sheet in a roll mill as it emanates from the extruder. The roll mill disperses the hydrophilic dopant across the substrate while at the same time evaporating any liquid present in the slurry. The pressure exerted by the roll mill depresses the hydrophilic dopant particles into the substrate 101.

The surface 103 of the article 100 is exposed to irradiative energy during use. The surface 104 is exposed to an area to be cooled by the article 100. In further embodiments, the surface 104 can be disposed upon additional material layers, such as water impermeable materials to reduce water infiltration into the interior space covered by the cooling article 100.

In one embodiment, a method of manufacturing an article such as a tent includes disposing upon a substrate a super-hydrophilic dopant. The substrate with the super-hydrophilic dopant disposed thereon is fabricated into a tent that has walls and a roof. The super-hydrophilic dopant is operative to absorb water from the substrate and to facilitate a conversion of water from a liquid phase to a vapor phase to reduce the temperature of a space enclosed within the tent.

The materials and methods detailed herein are further exemplified by the following non-limiting examples.

### EXAMPLE

### Example 1—Preparation of a Cooling Article Using a Pad-Dry-Cure Method

Dyed cotton fabric was padded with chitosan (1% weight in an aqueous solution of 1% acetic acid) at 80% pickup with a 2-roll horizontal padder (Type HF, WernerMathis AG). After padding, the treated fabric was oven-dried at 80° C. for 5 minutes. After drying, the fabric was soaked in an aqueous sodium carbonate solution (1%) overnight and then washed repeatedly until the pH reached 7. Separately, a titanium dioxide [4% weight per volume (% w/v)] dispersion was prepared by sonicating the TiO₂ powder [18 nanometers particles, US Nano Materials, Inc. (Houston, Texas)] in deionized water in a sonication bath for 3 hours. After sonication, trimethylene glycol (5% w/v) was added to the aqueous TiO₂ powder mixture and the mixture was stirred with magnetic stirring for 30 minutes. The chitosan-padded fabric was then padded twice with the TiO₂ dispersion at 80% pickup with a 2-roll horizontal padder (Type HF, WernerMathis AG).

### Example 2—Preparation of a Cooling Article with Impregnation

A 100% cotton piece of fabric (12 inches by 12 inches) was boiled in acetone. After boiling, the fabric was washed thoroughly in water. The fabric was then boiled in water for 30 minutes. A separate 10% solution of TiO₂ was prepared by mixing TiO₂ [18 nanometers particles, US Nano Materials, Inc. (Houston, Texas)] with diethylene glycol mono butyl ether. The TiO₂ was uniformly dispersed via sonication for 30 minutes. The cotton fabric was soaked in the 10% TiO₂ solution with boiling for 20 minutes at 150° C. After boiling the fabric was cooled to room temperature. A hot press was applied to the fabric (150° C. at 50 megapascals). The fabric was then gently rinsed with water and soaked in water for 24 hours. Then the fabric was dried in air at room temperature.

### Example 3—Use of the Cooling Article as a Tent

The interior temperature for three separate tent materials were compared on a hot, sunny morning. For the “normal tent,” an untreated, nylon commercial tent was used. For the “IR-reflective tent,” a Siesta IR-reflective tent with a built-in fan was used. The cooling article prepared as described in Example 1 was sewn onto the same nylon tent frame as used for the control tent and is labeled as “this tent” in FIG. 6. The cooling article was attached to portable water containers reservoir 166. The tent 170 of the FIG. 6 includes a plurality of walls 172 that contact each other to form a roof, wherein the plurality of walls and the roof are supported by a framework 168 that includes a plurality of assembled interconnected frame members that support the tent and define an enclosed space. The framework (that includes the plurality of assembled interconnected frame members that support the tent) may lie within the walls of the tent (i.e., they may lie inside the tent) or may lie outside the tent, such that the walls and/or roof of the tent are supported from the frame. The plurality of walls or the roof comprise a substrate (e.g., a flexible textile substrate) upon which is disposed the super-hydrophilic dopant. The super-hydrophilic dopant is operative to absorb water from the substrate and to facilitate a conversion of water from a liquid phase to a vapor phase thus reducing a temperature of the enclosed space.

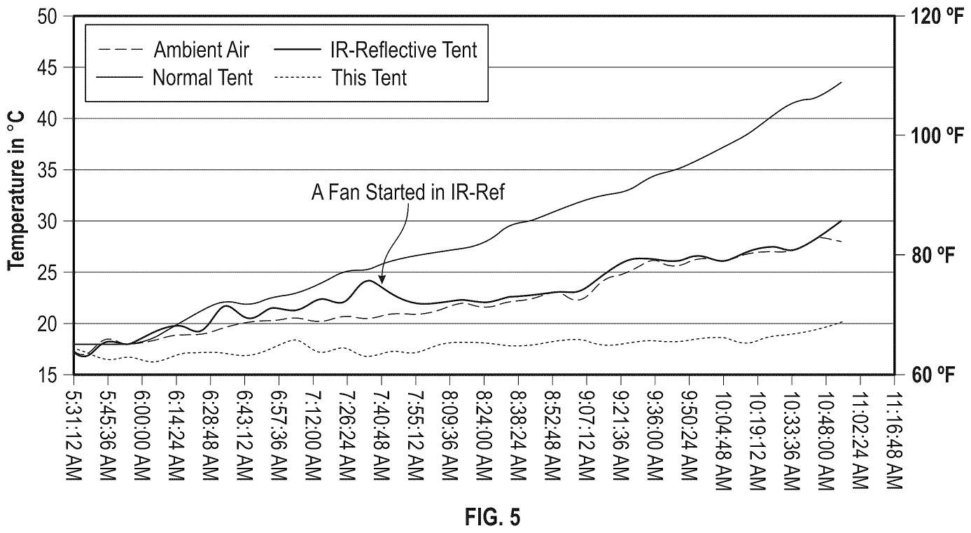

The interior temperatures of the three tents were recorded alongside the external ambient air temperature. FIG. 5 provides a graphical representation of the temperature changes over time for the three tents versus the ambient temperature. The control, untreated “normal tent” provided the highest interior temperatures. The “IR-reflective tent” in combination with a built-in, USB-powered fan provided temperatures similar to ambient temperatures. The cooling fabric tent “this tent” provided the lowest interior temperatures of all three tents examined with temperatures less than ambient temperatures.

### Example 4—Use of the Cooling Article of Example 2

The article prepared as described in Example 2 was placed under a UV-C irradiation lamp (peak 254 nanometers) for 30 minutes. The bottom side of the article was soaked in distilled water and kept upright. After 20 minutes, the entire article was wet. The surface temperature of the article was measured at 15° C. and the room temperature was measured at 25° C.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In some embodiments, the article is provided as a custom designed and sized retrofit to an existing structure, such as the tent. In some other embodiments, the article is integrated into a new structure and provides a structure with integrated cooling capabilities.

The drawings presented herein include, in some respects, abstractions of the technology set forth. For example, size and scale are varied in order to present elements discussed herein. It is not intended that actual embodiments accurately reflect the drawings.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

1. An article for removing heat from a volume upon which the article is disposed, comprising:
a substrate upon which is disposed a super-hydrophilic dopant, where the super-hydrophilic dopant is operative to absorb water from the substrate and to facilitate a conversion of water from a liquid phase to a vapor phase.

2. The article of claim 1, where the substrate is a woven or non-woven fibrous textile or a non-woven, non-fibrous sheet, where the fibrous textile or the non-fibrous sheet is hydrophilic.

3. The article of claim 1, where the substrate is a woven or non-woven fibrous textile or a non-woven, non-fibrous sheet, where the fibrous textile or the non-fibrous sheet is hydrophobic.

4. The article of claim 2, where the woven fibrous textile, the non-woven fibrous textile or the non-woven non-fibrous sheet comprises an organic polymer; where the organic polymer is a thermoplastic polymer that includes one of polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or a combination thereof.

5. The article of claim 2, where the woven fibrous textile, the non-woven fibrous textile or the non-woven non-fibrous sheet comprises an organic polymer; where the organic polymer is a thermosetting polymer that includes one of epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or a combination thereof.

6. The article of claim 2, where the woven fibrous textile, the non-woven fibrous textile or the non-woven non-fibrous sheet comprises a polyolefin, a polyester, a polyamide, or a combination thereof.

7. The article claim 2, where the woven fibrous textile, the non-woven fibrous textile or the non-woven non-fibrous sheet comprises one of a cotton, linen, hemp, flannel, wool, polyamides, polyester, polyolefin, or a combination thereof.

8. The article of claim 1, where the substrate is operative to wick water from a reservoir.

9. The article of claim 8, where the reservoir provides water to the article via gravity.

10. The article of claim 1, where the super-hydrophilic dopant is in the form of particles and where the particles are operative to absorb radiation and heat and to facilitate the conversion of water to vapor.

11. The article of claim 1, where the super-hydrophilic dopant has a contact angle of less than 5 degrees with water.

12. The article of claim 11, where the super-hydrophilic dopant is titanium dioxide, zinc oxide, tungsten trioxide, silica, or a combination thereof; and where the titanium dioxide is anatase titanium dioxide.

13. The article of claim 2, where the super-hydrophilic dopant is embedded in the substrate or where the super-hydrophilic dopant is intertwined in fibers of the fibrous textile.

14. The article of claim 1, where the substrate is further operative to absorb water from the hydrophilic dopant.

15. The article of claim 1, where the hydrophilic dopant is present on the substrate in an amount greater than the percolation threshold.

16. The article of claim 1, where the article is in fluid communication with a reservoir that contains water.

17. The article of claim 1, where the volume of space includes a space in a tent, a room, an apparel, a vehicle, or under an awning.

18. A tent comprising:
at least one wall and an optional roof; wherein the at least one wall and the optional roof define an enclosed space; where the tent is supported by a framework; where the framework lies within or outside the tent;
wherein the at least one wall and/or the optional roof comprise a substrate upon which is disposed a super-hydrophilic dopant; where the super-hydrophilic dopant is operative to absorb water and to facilitate a conversion of water from a liquid phase to a vapor phase to reduce a temperature of the enclosed space.

19. A method of manufacturing a tent comprising:
disposing upon a substrate a super-hydrophilic dopant; and
fabricating the substrate with the super-hydrophilic dopant disposed thereon into a tent; where the tent comprises a wall and an optional roof; and where the super-hydrophilic dopant is operative to absorb water from the substrate and to facilitate a conversion of water from a liquid phase to a vapor phase to reduce the temperature of a space enclosed within the tent.

20. The method of claim 19, further comprising disposing a structural framework at least partially inside or least partially outside the tent; where the framework is operative to support the wall and the optional roof of the tent.
